(19) United States
(12) Patent Application Publication
(10) Pub. No.: US 2016/0005063 A1
(43) Pub. Date: Jan. 7, 2016

(54) SYSTEM AND METHOD FOR ELECTRONIC ADJUSTMENT OF PRICES IN WEBSITES

(71) Applicant: Personali Inc., Waltham, MA (US)

(72) Inventors: Keren Zimmerman, Tel Aviv (IL); Noam JAVITS, Tel Aviv (IL)

(73) Assignee: PERSONALI INC., Waltham, MA (US)

(21) Appl. No.: 14/755,394

(22) Filed: Jun. 30, 2015

Related U.S. Application Data
(60) Provisional application No. 62/020,155, filed on Jul. 2, 2014.

(51) Int. Cl. G06Q 30/02

(52) U.S. Cl. CPC G06Q 30/0206; G06Q 30/0276

(57) ABSTRACT

A method and system for real-time price adjustment of products for sale on an e-commerce website are presented. The method includes receiving a request to adjust a price of at least one product; collecting at least one product parameter related to the at least one product; determining, based on the at least one product parameter, at least a minimum margin of the at least one product; computing an adjusted price for purchasing the at least one product for sale, wherein the computation is based on a current price set for the at least one product, the at least one product parameter, and the minimum margin; and causing a display of the adjusted price for display on the e-commerce website.

### CROSS-REFERENCE TO RELATED APPLICATIONS

This application claims the benefit of U.S. provisional application No. 62/020,155 filed on Jul. 2, 2014, the contents of which is herein incorporated by reference.

### TECHNICAL FIELD

This disclosure generally relates to a computerized platform for electronic commerce (e-commerce) websites and more specifically to a system and method for electronic adjustment of prices in e-commerce websites.

### BACKGROUND

The way people shop has significantly progressed since the development of the worldwide web (WWW). Consumers can now shop from the convenience of their home, office, or while on the road using portable devices. Popular websites such as Amazon.com® and Shopping.com®, though different by nature, allow consumers to purchase goods directly through the website, sometimes at a much lower price than the price suggested by local merchants. From a merchant's point of view, the WWW allows access to a worldwide market of consumers.

Large electronic commerce (e-commerce) websites operated by merchant devices may offer hundreds of thousands and even millions of different types of goods or services (collectively referred to as “products”) for sale within the e-commerce websites. The products offered for sale, as well as their associated costs, are constantly changing, which makes it difficult for merchants to determine the right price for the products as well as to adjust the prices when a need arises to do so.

Currently, merchants with large e-commerce websites must employ large workforces to manage prices and coordinate sales. Maintaining such a large workforce is expensive and managing the prices of all products for sale is extremely time consuming. Existing electronic solutions for price adjustment require data to be manually input, as such pricing of various products cannot be adjusted in real time.

It would therefore be advantageous to overcome the limitations of the prior art by providing an effective way to determine prices for products for sale in e-commerce websites.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for real-time price adjustment of products for sale on an e-commerce website. The method comprises: receiving a request to adjust a price of at least one product; collecting at least one product parameter related to the at least one product; determining, based on the at least one product parameter, at least a minimum margin of the at least one product; computing an adjusted price for purchasing the at least one product for sale, wherein the computation is based on a current price set for the at least one product, the at least one product parameter, and the minimum margin; and causing a display of the adjusted price for display on the e-commerce website.

Certain embodiments disclosed herein include a system for real-time price adjustment of products for sale on an e-commerce website. The system comprises: a processing unit; and a memory connected to the processing unit that contains instructions that when executed by the processing unit configures the system to: receive a request to adjust a price of at least one product; collect at least one product parameter related to the at least one product; determine, based on the at least one product parameter, at least a minimum margin of the at least one product; compute an adjusted price for purchasing the at least one product for sale, wherein the computation is based on a current price set for the at least one product, the at least one product parameter, and the minimum margin; and cause a display of the adjusted price for display on the e-commerce website.

### BRIEF DESCRIPTION OF THE DRAWINGS

The subject matter that is regarded as the disclosed embodiments is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system utilized to describe the various embodiments disclosed herein.

FIG. 2 is a flowchart depicting a method for electronic price adjustment of products according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

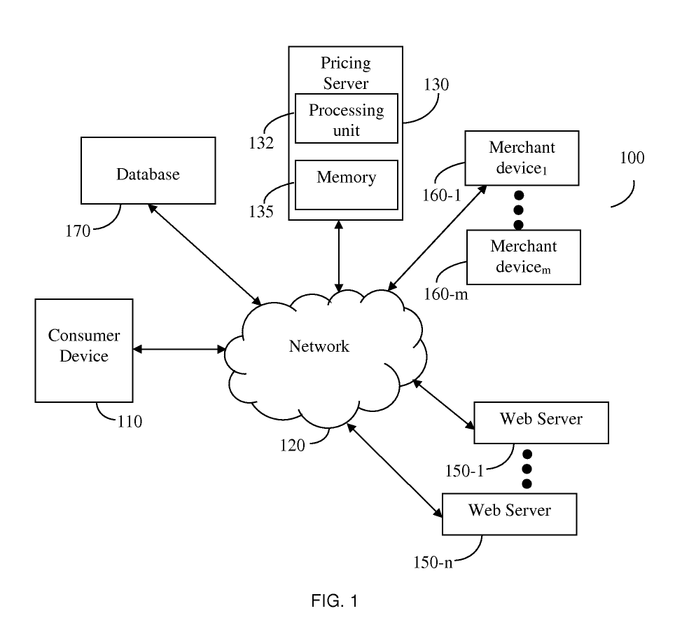

FIG. 1 depicts an exemplary and non-limiting schematic diagram of a networked system 100 utilized to describe the various disclosed embodiments. The networked system 100 includes at least one consumer device 110, a pricing server 130, a plurality of web servers 150-1 through 150-m, a plurality of merchant devices 160-1 through 160-m, and a database 170 communicatively connected to a network 120. The network 120 can be wired or wireless, a local area network (LAN), a wide area network (WAN), a metro area network (MAN), the Internet, the worldwide web (WWW), the likes, and any combinations thereof.

The consumer device 110, may include, but is not limited to, a personal computer (PC), a laptop computer, a mobile device, a wearable computing device, or any computing device with at least web browsing capabilities. The web servers 150-1 through 150-n (collectively referred hereinafter as web servers 150 or individually as a web server 150, merely for simplicity purposes) host e-commerce websites including, for example, travel websites, services websites and any other website through which the user is able to purchase goods and/or services. The web servers 150-1 through 150-n are operative by merchant devices 160-1 through 160-m respectively (collectively referred hereinafter as merchant devices 160 or individually as a merchant device 160, merely for simplicity purposes). For example and without limitation, the e-commerce website hosted by the server 150-1 may be www.walmart.com and the respective merchant 160-1 may be Walmart®. It should be noted that one merchant 160 can be the owner or operator of more than one website hosted by the web servers 150.

The consumer device 110 is configured to allow access to websites for at least the purpose of performing electronic commerce (e-commerce) transactions. That is, a user of the consumer device 110 can browser various goods or services (collectively referred to as “products” or “product”), purchase a product or products, and have the purchase shipped to the user's location. As noted above, the prior art solutions do not allow the merchant to adjust the prices of various products automatically and in real-time.

According to the disclosed embodiments, the pricing server 130 is configured to adjust the prices of products in real-time to incentivize a consumer to purchase a product. To this end, the pricing server 130 is configured to receive a request to adjust the price of at least one product offered for sale. The request may be received from the merchant device 160. The product may be a specific good or service, a specific brand, a specific category of goods or services, and so on. The pricing server 130 is then configured to collect parameters related to the product to which the price should be adjusted.

In an exemplary and non-limiting embodiment, the collection of parameters may be achieved by crawling through the websites hosted by the web servers 150 and identifying the product information. It should be noted the crawling may be through the websites of the merchant requesting the adjustment, other websites offering the same product, and/or vendors of the product. The collection of product parameters may further include retrieval of data related to the product from a database 170.

The collected product parameters may include, for example, the type of product, its current price, shipping information, inventory information, special offers, a retail price, associated taxes, and the like.

Based on one or more parameters related to the product, the pricing server 130 is configured to determine in real-time a minimum margin of the product. The minimum margin represents the minimum price for the merchant associated with the merchant device 160 to sell the product while maintaining a minimum profit.

According to one embodiment, the pricing sever 130 is configured to compute a minimum margin for a specific product, a product category, or a group of related products (for example, a smartphone and related accessories). In an exemplary implementation, the minimum margin is computed, in part, as a function of the shipping costs associated with the delivery of the product. The shipping costs are determined based on an analysis of the size of the product as well as other formal characteristics related to the product. The computation of the minimum margin may be also a function of financial targets input received from the merchant device 160. Based on the financial targets and a time pointer determined by the pricing server 130, the pricing server 130 is configured to compute a minimum margin plan required in order to meet the financial targets. As an example, a request is received by a merchant to generate a profit of more than 1 million US dollars in a financial year. Respective thereof, the pricing server 130 determines a certain minimum margin respective of a plurality of product types in order to achieve the requested revenue. The pricing server 130 continuously monitors the revenue generated and the respective profit in order to verify that it is corresponding to the expectations. The pricing server 130 may adapt the minimum margin upon determination of a deviation from the expectations. It should be noted that the minimum margin plan may be adaptive, and therefore represent changes over time respective of the financial targets.

Based on the minimum margin, the pricing server 130 is further configured to generate an adjusted price for the products. According to one embodiment, the adjusted price may be offered only to a group of consumer devices 110. To this end, one or more identifiers related to such consumer device(s) 110 are determined. For example, the identifiers may be geographic locations of the consumer devices, engagement of the consumers of such device with the e-commerce website or a specific product, and so on. For example, if the shipping costs of a particular product from a warehouse to a location of a group of consumers located in New York City is lower than the cost to ship to consumers in Los Angeles, the price of the product will be adjusted accordingly to consumers located in New York.

In an embodiment, the pricing server 130 implements a threshold based alert system responsive to the adjusted prices. In this embodiment, upon identification that the adjusted price is different from the original price in an amount higher than a predetermined threshold, an alert is provided to the merchant device 160. Such alerts are required in order to align with a marketing strategy of a merchant associated with a merchant device 160. As an example, upon launching a new technological product for sale a merchant may want to keep it at a higher price than the minimum margin as the demand is expected to be high.

According to another embodiment, the server 130 is further configured to initiate and coordinate electronic marketing campaigns for selling products. Such a campaign may include customized discounts to different products respective of the minimum margin computed for each product. The campaigns may be initiated based on a request by a merchant device 160. The request for the campaign may include one or more rules related to the price adjustments as well as one or more thresholds for minimum margins.

As a non-limiting example, a request for a campaign in the dishwashers' category on an e-commerce website, for example, the e-commerce website 150-1, is received. The request includes a definition of a minimum margin for selling the dishwashers within the dishwashers' category. According to this example, a discount in the price of the products within the dishwashers' category is made only for dishwashers that are priced above the minimum margin threshold as defined by the merchant device 160. The adjusted price may include a discount or an increase over the original price. According to yet another embodiment, the adjusted price is displayed by the pricing server 130 on the display of the consumer device 110.

The pricing server 130 typically comprises a processing unit 132, coupled to a memory 135. The processing unit 132 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may be coupled to the memory 135. In an embodiment, the memory 135 contains instructions that when executed by the processing unit 132 results in the performance of the methods and processes described herein below. Specifically, the processing unit 132 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 140 to perform the various functions described herein.

It should be noted that in certain implementations, the processes for adjusting the prices of products can be integrated in one or more of the web servers 150.

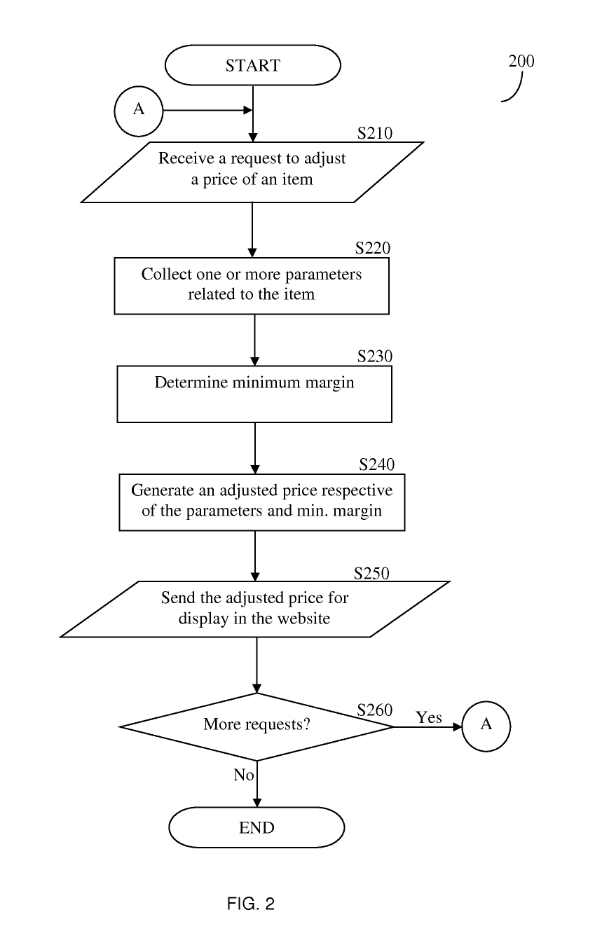

FIG. 2 depicts an exemplary and non-limiting flowchart 200 depicting a method for electronic price adjustment of products according to one embodiment. The method may be performed by a dedicated server, e.g., the pricing server 130, a web server (e.g., a web server 150), or a combination thereof.

In S210, a request to adjust a price of at least one product for sale on an e-commerce website is received. The request may be received from a merchant device of a merchant operating the e-commerce website. In another embodiment, the request is automatically generated at predetermined time intervals. In S220, at least one product parameter is collected for the at least one product. A product parameter may include, for example, a type of product, its current price, shipping information, inventory information, special offers, a maximum suggest retail price (MSRP), a cost of the product to the merchant, associated taxes, and the like. Various embodiments for collecting the product parameter are discussed above. Optionally, one or more merchant parameters are collected. In a further optional embodiment, one or more identifiers related to consumers visiting the e-commerce website are collected.

In S230, a minimum margin of the at least one product designated in the request is computed. The computation is performed in real-time based on the at least one product parameter (and optionally merchant parameter) collected. According to one embodiment, the minimum margin may be computed for the specific product, a product category, or a group of related products. In addition to the collected parameters, the minimum margin may be a function of a few constraints, such as shipping costs. The computation of the minimum margin includes determination of the shipping costs associated with the delivery of the product and financial targets as set by the merchant. The shipping costs are determined based on an analysis of the size of the product, the geographic location in which the product is currently available, and shipment to different popular locations. In an embodiment, based on the financial targets and a time pointer, a minimum margin plan required in order to meet the financial targets is determined. It should be noted that the minimum margin plan may be adaptive and therefore change over time respective of the financial targets.

In S240, an adjusted price is computed, in real-time, as a function of the current price of the product and the at least one of the collected product parameters. In an exemplary and non-limiting embodiment, each product parameter may be assigned with a range of values indicating a reduction factor on the current product price. The reduction factor is a function of a value of a respective parameter and may be changed from one parameter to another. For example, for high inventory the reduction factor may be high as more products can be sold and for low inventory the reduction factor may be a low value. According to this exemplary embodiment, if the reduction factor is 10% for high inventory products, a 10% reduction will be applied on the current price to result in the adjusted price; and if the inventory is low a 2% reduction factor will be applied on the current price of the product. The high and low inventory may be determined by comparing to a predefined threshold defined by the merchant. It should be appreciated that as the value of a product parameter (e.g., the inventory level) changes, the price is adjusted, thereby allowing price adjustments overtime.

The minimal margin may represent a lower boundary for the adjusted price, that is, the adjusted price cannot be less than the minimal margin. The adjusted price may be computed for the specific product, a product category, or a group of related products.

In an embodiment, the price may be adjusted differently for different consumers identified by the collected user identifiers. To this end, different reduction factors can be set for different group of consumers. As an example, a higher reduction factor may be set to consumer showing interest in a certain product over consumers that visits the e-commerce website for the first time.

In S250, the adjusted price is displayed on the e-commerce website. In S260, it is checked whether there are additional requests and if so, execution continues with S210; otherwise, execution terminates.

As a non-limiting example, a request to adjust a price of a microwave oven on an e-commerce website is received by the pricing server from a merchant server. The original price of the microwave oven is $99. A minimum margin of the oven is computed to be $80 based on the shipping costs and financial target of the respective merchant. A reduction factor of the oven is 10% as the merchant has a high inventory of ovens. Therefore, the adjusted price is $89 as the $99 original price is reduced by 10% and $89 is above the minimum margin of $80. The adjusted price of $89 is then displayed on the e-commerce website. The various embodiments of the disclosure are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for real-time price adjustment of products for sale on an e-commerce website, comprising:
receiving a request to adjust a price of at least one product;
collecting at least one product parameter related to the at least one product;
determining, based on the at least one product parameter, at least a minimum margin of the at least one product;
computing an adjusted price for purchasing the at least one product for sale, wherein the computation is based on a current price set for the at least one product, the at least one product parameter, and the minimum margin; and
causing a display of the adjusted price for display on the e-commerce website.

2. The method of claim 1, further comprising:
collecting at least one identifier for each consumer visiting the e-commerce website; and
adjusting the price of the at least one product individually for at least one consumer having common identifiers.

3. The method of claim 2, wherein the at least one identifier includes at least one of: a geographical location of the consumer and an interest level of the consumer in the at least one product.

4. The method of claim 1, wherein computing the adjusted price for purchasing further comprises:
assigning a range of values for each of the at least one product parameter indicating a reduction factor; and
applying the reduction factor on the current price based on the current value of each of the at least one product parameter.

5. The method of claim 4, further comprising:
checking that the adjusted price is greater than or equal to the minimum margin.

6. The method of claim 1, wherein the at least one product parameter is any one of: a type of product, a price, shipping information, an inventory level, an associated cost, and associated taxes.

7. The method of claim 1, wherein determining the minimum margin further comprises:
determining shipping costs associated with delivery of the product and at least one financial target set by a merchant.

8. The method of claim 1, wherein the at least one product is any one of:
goods, a service, and a product category.

9. A non-transitory computer readable medium having stored thereon instructions for causing one or more processing units to execute the method according to claim 1.

10. A system for real-time price adjustment of products for sale on an e-commerce website, comprising:
a processing unit; and
a memory connected to the processing unit that contains instructions that when executed by the processing unit configures the system to:
receive a request to adjust a price of at least one product;
collect at least one product parameter related to the at least one product;
determine, based on the at least one product parameter, at least a minimum margin of the at least one product;
compute an adjusted price for purchasing the at least one product for sale, wherein the computation is based on a current price set for the at least one product, the at least one product parameter, and the minimum margin; and
cause a display of the adjusted price for display on the e-commerce website.

11. The system of claim 10, further configured to:
collect at least one identifier for each consumer visiting the e-commerce website; and
adjust the price of the at least one product individually for at least one consumer having common identifiers.

12. The system of claim 11, wherein the at least one identifier includes at least one of: a geographical location of the consumer and an interest level of the consumer in the at least one product.

13. The system of claim 10, wherein computing the adjusted price for purchasing further comprises:
assigning a range of values for each of the at least one product parameter indicating a reduction factor; and
applying the reduction factor on the current price based on the current value of each of the at least one product parameter.

14. The system of claim 13, further configured to:
check that the adjusted price is greater than or equal to the minimum margin.

15. The system of claim 10, wherein the at least one product parameter is any one of: a type of product, a price, shipping information, an inventory level, an associated cost, and associated taxes.

16. The system of claim 10, wherein determining the minimum margin further comprises:
determining shipping costs associated with delivery of the product and at least one financial target set by a merchant.

17. The method of claim 10, wherein the at least one product is any one of: goods, a service, and a product category.
